(19) United States
(12) Patent Application Publication
(10) Pub. No.: US 2014/0108047 A1
(43) Pub. Date: Apr. 17, 2014

(54) Methods and systems for medical auto-coding using multiple agents with automatic adjustment

(71) Applicant: Atigeo LLC, Bellevue, WA (US)

(72) Inventors: Rodney Kinney, Bellevue, WA (US); Michael Sandoval, Bellevue, WA (US); David Talby, Bellevue, WA (US); Robert Payne, Bellevue, WA (US); Bryan Tinsley, Bellevue, WA (US); Alex Thomas, Bellevue, WA (US)

(73) Assignee: Atigeo LLC, Bellevue, WA (US)

(21) Appl. No.: 13/998,039

(22) Filed: Sep. 23, 2013

Related U.S. Application Data
(60) Provisional application No. 61/704,350, filed on Sep. 21, 2012.

(51) Int. Cl. G06F 19/00

(52) U.S. Cl. CPC G06F 19/328; G06F 19/322
USPC 705/3

(57) ABSTRACT

This disclosure is directed to methods and automated documentation and medical-coding systems that combine predictions of clinical decision support or multiple medical-code assignments into a final medical-code assignment, such that the combination is different for different contexts. In certain implementations, each agent receives the same set of terms and phrases extracted from an electronic medical record (“EMR”). Based on the context of the EMR, each agent extracts medical codes from one or more medical codebooks, compares the terms and phrases to the medical codes, and assigns a code to the EMR based on a confidence score. The multiple code assignments are combined to generate a final medical-code assignment based on the confidence scores, context, and each agent's historical performance within the context. The automated system stores and outputs the final medical-code assignment.

### CROSS-REFERENCE TO RELATED APPLICATION

This application claims the benefit of Provisional Application No. 61/704,350, filed Sep. 21, 2012.

### TECHNICAL FIELD

The current document is related to electronic medical records and data processing and, in particular, to methods and systems that analyze and adjust medical codes.

### BACKGROUND

Over the past 20 years, the health-care industry has progressively transformed record keeping and data processing to allow for an ever-greater degree of automation, using modern economical computer systems with large data-storage capacities and large computational bandwidths. It is expected that patient records and information will soon be entirely encoded and maintained in electronic medical records. Electronic medical records have many advantages over paper-document-based files and older data-storage media, including cost efficiency, standardization, rapid and straightforward transfer of electronic medical records among health-care providers, health-care-providing organizations, and insurance companies, and efficient processing and analysis of electronic medical records using powerful application programs running on large, distributed computer systems, including cloud-computing systems. Nonetheless, the information stored in electronic medical records (“EMRs”) is often initially generated manually by a physician or other health-care provider through dictation, electronic data-entry applications, and by other means.

During processing of an EMR, particularly for generation of a billing statement by a health-care provider for submission to an insurance company, individual medical codes that are related to the information contained within the EMR, such as individual medical codes selected from one or more of the various revisions of the International Classification of Diseases medical codebook, including the ICD9 and ICD10 medical codebooks, the Current Procedural Terminology (“CPT”) medical codebook, the Systematized Nomenclature of Medicine (“SNOMED”) medical codebook, and other medical codebooks, need to be identified and associated with the EMR. The related individual medical codes, once identified for a particular EMR, are incorporated within the EMR or associated with the electronic medical record. The related individual medical codes may serve as easily processed summaries of the information content of the electronic medical record that can be used by automated systems to facilitate generation and processing of billing statements and may be used for a variety of additional types of analyses, including various types of research, quality-control, auditing, and other types of analyses carried out by, or on behalf of, various types of health-care providers and health-care-providing organizations.

Traditionally, the identification and assignment of medical codes to electronic medical records has been a largely manual or computer-assisted manual task carried out by trained analysts. However, with the emergence of modern economical computer systems with large data-storage capacities and large computational bandwidths, efforts have been undertaken to at least partially automate the medical-code-assignment process. Unfortunately, to date, these efforts have fallen short of desired accuracy, precision, and reliability. Researchers and developers, vendors and manufacturers of automated systems, and, ultimately, health-care providers and health-care-providing organizations continue to seek an automated medical-coding system that provides adequate accuracy, precision, and reliability in the automated assignment of medical codes to electronic medical records.

### SUMMARY

The current document is directed to methods and automated documentation and medical-coding systems that combine predictions of clinical decision support or multiple medical-code assignments into a final medical-code assignment, such that the combination is different for different contexts. In certain implementations, the automated system generates multiple code assignments using two or more agents executed within the automated system. Each agent is a computational method that receives the same set of terms and phrases extracted from an electronic medical record (“EMR”). Based on the context of the EMR, each agent extracts medical codes from one or more medical codebooks, compares the terms and phrases to the medical codes, and assigns a confidence score for each code. The code assignments made by the different agents are combined to generate a final medical-code assignment based on the confidence scores, context, and each agent's historical performance within the context. The automated system stores and outputs the final medical-code assignment or produces an error which recommends necessary inferred documentation missing in order to satisfy a probabilistically likely intended code. The system may allow a fraction of the EMRs and their final medical code assigments to be reviewed in order to correct errors. The record of changes made by the analyst may be sent back to the automated system and used to update parameters used to calculate subsequent medical code assignments.

### DESCRIPTION OF THE DRAWINGS

FIG. 1 provides a general architectural diagram for various types of computers, including computer systems that execute stored computer instructions that implement an automated medical-coding system.

FIG. 2 illustrates an automated process carried by N agents that each assigns medical codes to an electronic medical record.

FIG. 3 illustrates a stream-comparison operation used in implementations to evaluate individual medical codes within a medical codebook with respect to a particular electronic medical record.

FIG. 4 illustrates use of the results of the stream-comparison operation, discussed above with reference to FIG. 3, to select a set of medical codes with high probability of being related to the information contained within an electronic medical record.

FIG. 5 illustrates training and feedback aspects of the disclosed methods and systems.

FIG. 6 shows an example of an electronic medical record.

FIG. 7 illustrates organization of a typical medical codebook.

FIG. 8 illustrates one type of hierarchical organization within a medical codebook.

FIGS. 9A-9B show small portions of an actual medical codebook.

FIG. 10 illustrates aspects of the training compare operation, discussed above with reference to FIG. 5, in which medical codes associated with an EMR by an agent are compared to the medical codes associated with the same EMR by human analysts or by another method.

FIG. 11 illustrates a list of code/score pairs for a final medical-code assignment generated by combining assigned codes/score pairs of N different medical-code assignments, each generated by a different agent.

FIG. 12 illustrates a collection of scores generated by N different agents.

FIGS. 13A-13B illustrate generating a set of final scores and codes for an electronic medical record with respect to a particular context.

FIG. 14 illustrates final results generated by an automated system that receives an electronic medical record and combines predictions of multiple medical code assignments, with respect to a particular context X.

FIGS. 15A-15C illustrate aspects of updating context-agent weights.

FIGS. 16A-16C provide control-flow diagrams that illustrate one implementation of an automated medical code system that assigns medical codes to electronic medical records.

### DETAILED DESCRIPTION

The current document is directed to automated documentation and medical-coding systems, and methods incorporated within the automated systems, that combine predictions of clinical decision support or multiple medical-code assignments to an electronic medical record (“EMR”) into a final medical-code assignment for the EMR. Each code assignment is generated by one of two or more agents executed within the automated system. Each agent is a computational method that receives the same set of terms and phrases extracted from an EMR. Based on the context of the EMR, each agent extracts medical codes from one or more medical codebooks, compares the terms and phrases to the medical codes, and assigns a code to the EMR based on a calculated confidence score. The confidence score indicates the agent's confidence in its predicted assignment of medical codes. The code assignments made by the different agents are combined to generate a final medical-code assignment based on the scores, knowledge of the context, and each agent's historical performance within that context. The automated system stores and outputs the final medical-code assignment that may be sent to a code reporting system that handles the assigned codes for purposes of billing and record-keeping. The system may allow a fraction of the EMRs and their assigned codes to be reviewed by an analyst, such as a human analyst. The analyst will leave correctly assigned codes alone, and correct errors by adding missed medical codes or removing incorrect medical codes or request identified necessary inferred or expected documentation missing in order to satisfy a probabilistically likely intended code. The record of changes made by the analyst may be sent back to the automated system and used to update parameters used to calculate subsequent medical code assignments.

It should be noted, at the onset, that the currently disclosed methods carry out real-world operations on physical systems and the currently disclosed systems are real-world physical systems. Implementations of the currently disclosed subject matter may, in part, include computer instructions that are stored on physical data-storage media and that are executed by one or more processors in order to analyze EMRs and to assign individual medical codes of one or more medical codebooks to the EMRs. These stored computer instructions are neither abstract nor fairly characterized as “software only” or “merely software.” They are control components of the systems to which the current document is directed that are no less physical than processors, sensors, and other physical devices.

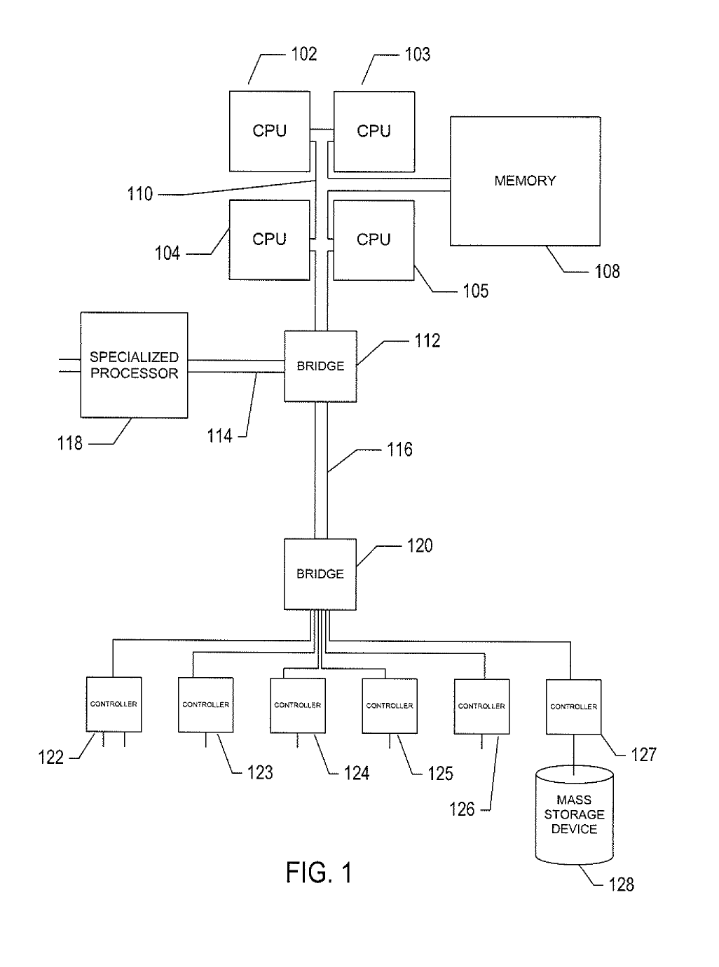

FIG. 1 provides a general architectural diagram for various types of computers, including computer systems that execute stored computer instructions that implement an automated medical-coding system. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational resources.

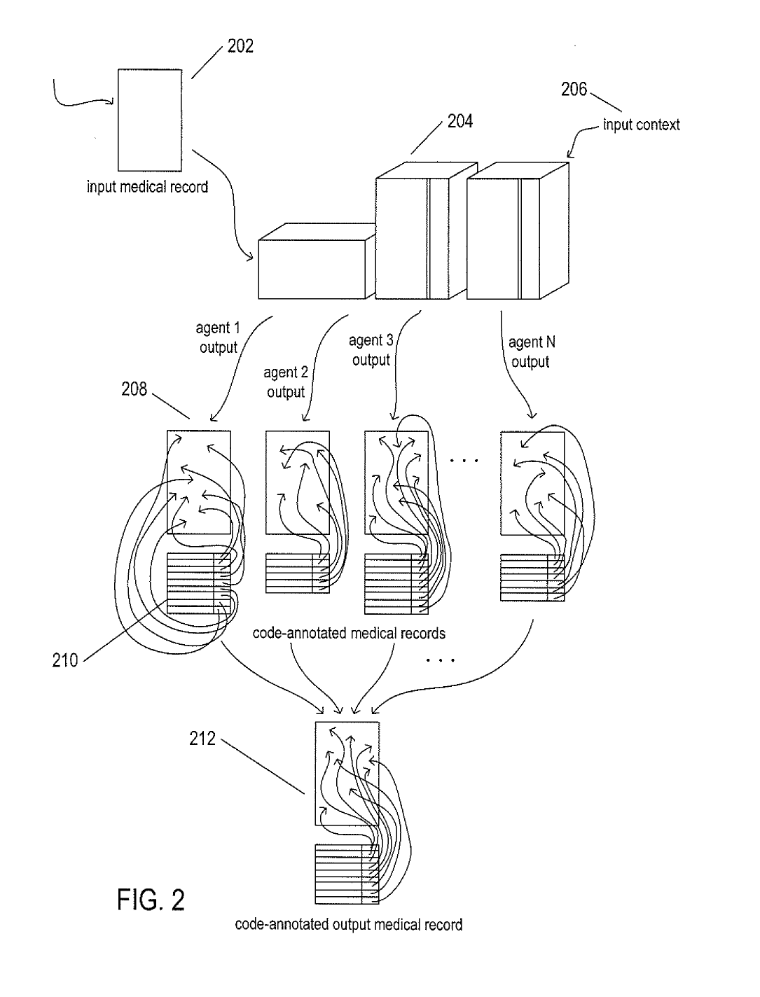

FIG. 2 illustrates an automated process carried by N agents that each assigns medical codes to an electronic medical record. As shown in FIG. 2, an EMR 202 is input to an automated system 204 that assigns codes to the input EMR. The system 204 executes N different agents that each implement a different approach to computing a medical-code assignment based on a context 206 associated with the EMR 202. Context refers to some structural information that is known about the EMR being examined. For example, all EMRs coming from a radiology clinic may form one context, while records coming from a neonatology clinic may form another context. A context may also be EMRs coming from a particular provider, for example a given hospital group or medical practice. Each agent may employ a different method to analyzing the EMR. For example, one agent may implement a rules-based method, in which human analysts define logical rules that map the presence or absence of terms and phrases of the EMR to the appropriateness of a medical code. A second agent may implement an automated classification method, in which historical medical records are examined for terms and phrases that correlate with a given medical code. A third agent may implement a search-engine method, in which terms and phrases are matched against sources of data that are linked to a medical code without having historical examples of medical records with that code attached. The strengths of the different agents may vary depending on the context in which the EMR is generated. For example, the first agent may be expected to perform well in limited specialties where human analysts can be expected to reasonably cover all possibilities. The second agent may perform well when there is a large historical backlog of human-coded medical records for a particular provider. The third agent may perform well for codes that belong to widely-varying specialties in which historical examples of certain codes are rare.

Each agent analyzes the information content of the EMR, identifies those individual medical codes within one or more medical codebooks with highest probability of being related to the information contained within each EMR, and electronically annotates each EMR with the identified individual medical codes, outputting the code-annotated EMRs 208. Each code-annotated EMR 208 represents a medical-code assignment. The code-annotated EMRs 208 may be stored temporarily or for a long period of time within the automated medical-coding system 204. In FIG. 2, the code annotations produced by each agent are represented as tables, such as table 210 generated by a first agent, each entry of which includes a medical code as well as a reference or pointer to a word, phrase, sentence, or paragraph within the EMR to which the medical code is related. In practice, each entry would generally contain at least one, and often, multiple references to terms and phrases within the EMR. There are, however, many different possible ways in which an EMR can be electronically annotated. For example, related codes can be inserted directly into the text of an EMR. Alternatively, the related codes may be stored in a second electronic document associated with the EMR or may be alternatively stored within indexed files, one or more database systems, or other types of electronic data-storage facilities. The code-annotated EMRs 208 are then combined to generate a final code-annotated EMR 212 based on the context of the EMR and historical performance of the agents. The final code-annotated EMR 212 represents a final medical-code assignment. The final code-annotated EMR 212 may be transmitted by the automated medical-coding system 204 to remote computer systems, including remote computer systems maintained by insurance companies, health-care-providing organizations and systems that use the assigned codes for purposes of billing and record keeping.

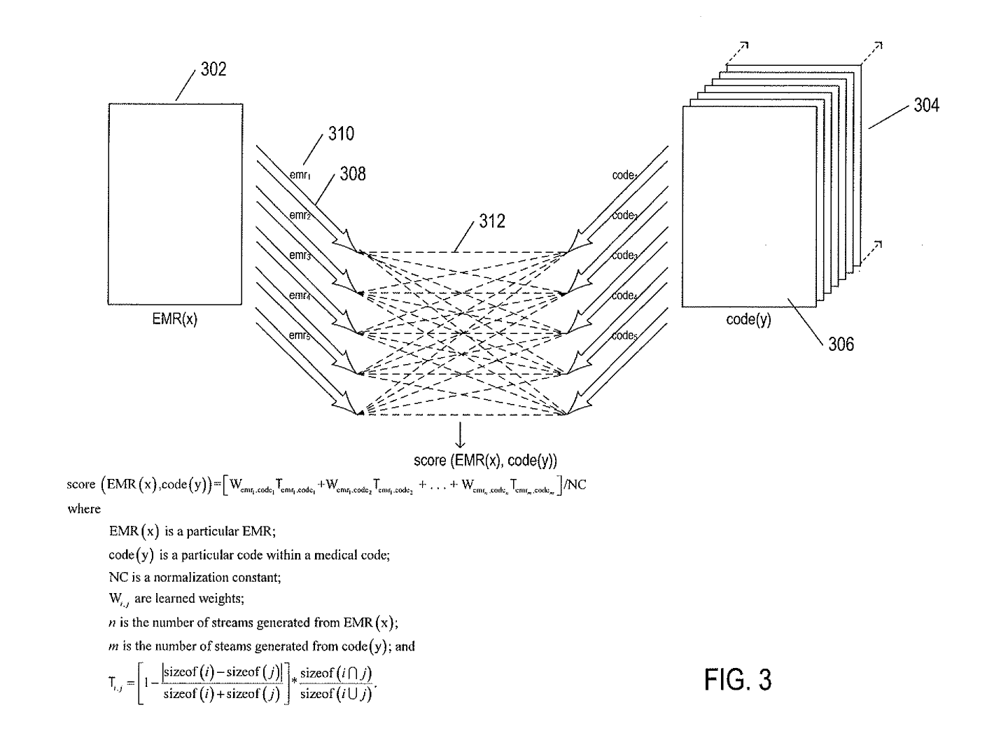

FIGS. 3-10 illustrate an example of a computational method for assigning codes to terms and phrases of an EMR that may be performed by one or more of the agents executed by the automated medical-coded system 204 and is described in greater detail in U.S. patent application Ser. No. 13/960,054 filed Aug. 6, 2012 and owned by Atigeo, LLC. The method described below with reference to FIGS. 3-10 is intended to represent just one of many different methods may be implemented by an agent to assign medical codes to terms and phrases of an EMR. Other methods for assigning codes to terms and phrases of an EMR may be implemented by different agents executed by the automated system 204.

FIG. 3 illustrates a stream-comparison operation used in implementations to evaluate individual medical codes within a medical codebook with respect to a particular EMR. The stream-valuation method produces a real-valued score in the range [0,1], in this implementation. The larger the magnitude of the score, the greater the probability that the individual medical code is related to, or applicable to, the particular EMR with respect to which the individual medical code is evaluated in the stream-comparison operation. Of course, an opposite convention can be used, in which lower-magnitude scores indicate greater relatedness. Other conventions are also possible.

In FIG. 3, the comparison of an individual medical code from a medical codebook to the information contained within a specific EMR is illustrated. The specific EMR 302 is described by the notation “EMR(x).” In general, an EMR is a text file or document that describes a patient, a patient visit, a procedure, a patient history, pharmaceuticals administered to the patient, and other such information. An example EMR is discussed below.

The medical codebook 304 is a generally voluminous compendium of individual medical codes, including numeric or alphanumeric codes along with textural descriptions of the codes. Medical codebooks are generally stored electronically within any of various types of electronic data-storage devices or systems. In many cases, medical codebooks are hierarchically organized into chapters and lower-level sections and subsections, as discussed further below. An automated system can be controlled to extract individual medical codes and associated descriptions from a medical codebook. In FIG. 3, the automated system has extracted a particular code 306, code(y), from the medical codebook 304.

The automated system generates multiple streams of terms or multiple streams of terms and phrases from both the particular EMR, EMR(x), and the particular code, code(y). In FIG. 3, each stream of terms or terms and phrases is represented by an arrow, such as stream 308 produced from the contents of EMR(x) 302. In FIG. 3, each stream is labeled with a stream identifier, such as the identifier “emr₁” 310 that identifies stream 308. The generation of the streams from the EMR and individual medical code are discussed further, below. In general, each stream comprises a sequence of terms or terms and phrases extracted from either the EMR or individual medical code or from additional sources of terms or terms and phrases, including medical dictionaries, portions of the medical codebook other than the description of the individual extracted code, and other such sources.

In certain implementations, the streams are composed entirely of terms. In other implementations, the streams may include both terms and short phrases. In the latter case, the term and phrases may be separated by delimiter symbols, such as commas.

As indicated in FIG. 3 by dashed lines, such as dashed line 312, the comparison operation that generates a score for a particular EMR/individual-code pair involves comparison of each possible pair of streams that include a stream generated from the EMR and a stream generated from the individual medical code. In other words, the stream-comparison operation involves a cross-product-like comparison of all possible stream pairs that include a stream generated from the EMR and a stream generated from the individual medical code.

As indicated in FIG. 3, in one implementation, the score generated by the stream-comparison operation for a particular individual medical code with respect to a particular EMR, score(EMR(x), code(y)), is computed as a sum of terms divided by a normalization constant:

$$score ( EMR ( x ) , code ( y ) ) = \frac{1}{NC} [ {\sum }_{i = 1}^{n} {\sum }_{j = 1}^{m} {W}_{{emr}_{i} {code}_{j}} {T}_{{emr}_{i} {code}_{j}} ]$$

where

EMR(x) is a particular EMR;

code(y) is a particular code within a medical code;

NC is a normalization constant;

W_{i,j} are learned weights;

n is the number of streams generated from EMR(x);

m is the number of streams generated from code(y); and

$${T}_{i , j} = [ 1 - \frac{\vert sizeof ( i ) - sizeof ( j ) \vert}{sizeof ( i ) + sizeof ( j )} ] * \frac{sizeof ( i ⋂ j )}{sizeof ( i ⋃ j )}$$

Thus, each term in the sum of terms is the product of a weight W_{i,j} for a particular stream pair, i and j, and a term T_{i,j} that is computed as a product of two quantities. The first quantity has the value 1 when the size of the two streams is equal and decreases with increasing disparity in the sizes of the two streams and the second term is the ratio of the number of terms or terms and phrases common to both streams divided by the total number of different terms or terms and phrases in both streams, represented in the above equation using set intersection ∩ and set union ∪. The normalization constant NC may be the total number of terms in the sum of terms used to compute the score, but may also be a different normalization constant, in alternative implementations. The weights W_{i,j} are learned by the automated system from training data comprising EMRs with code annotations produced by either human analysts or by some other means other than by the automated system that is being trained. Training is discussed in greater detail below.

Thus, the score is computed as a weighted sum of terms, each term reflective of the similarity between the terms or terms and phrases within each possible pairwise combination of streams from the particular EMR and particular code being compared with respect to the particular EMR. Over time, the agent adjusts the values of the different weights so that those pairs of streams most reflective of the relevance of a particular code to a particular EMR provide greater input to the final score generated in the stream comparison operation. The above expression is but one possible approach to generating a stream-comparison score. In alternative approaches, the score may have both negative and positive values, such as being in the range [−1,1], with the weights also having both positive and negative values. The terms may be alternatively computed, in alternative implementations. In general, the score reflects the likelihood that a particular code is related to a particular EMR. The magnitudes of the individual terms in the expression for the score may additionally provide indications of the particular terms or terms and phrases within the EMR specifically related to a particular code, allowing the automated system to map related medical codes from a medical codebook back to particular terms or terms and phrases within an EMR to which they are related, thus providing the references discussed above with reference to FIG. 2.

A medical codebook may also be subdivided into a set of two or more subcodes. Each of the subcodes may then be associated with a different set of weights. During the stream-comparison operation discussed above with reference to FIG. 3, the weights associated with a subcode from which a currently considered code is extracted and evaluated with respect to a particular EMR are used in the scoring operation. Thus, the granularity of learning may descend to the level of an arbitrary number of subcodes to improve scoring.

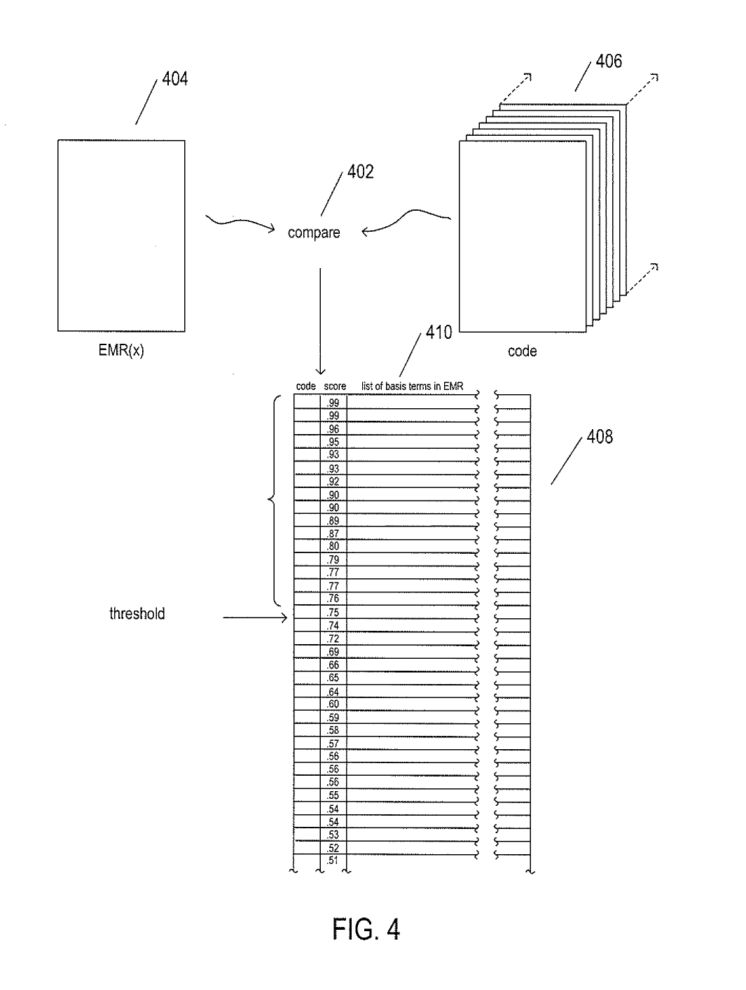

FIG. 4 illustrates use of the results of the stream-comparison operation, discussed above with reference to FIG. 3, to select a set of medical codes with high probability of being related to the information contained within an EMR. As shown in FIG. 4, the stream-comparison operation 402 on the multiple term or term-and-phrase streams generated from a particular EMR 404 and each of multiple codes selected from a medical codebook 406 generate a set of codes associated with scores. These codes with associated scores are sorted, in descending order, by the magnitude of the scores to generate a sorted list 408 of code/score pairs. This assumes the convention in which scores with greater magnitudes. In certain implementations, the code/score pairs may be supplemented with a list of the basis terms or terms and phrases in the EMR, shown in column 410 in FIG. 4, that contributed significantly to the magnitude of the score for the code. This list of basis terms or terms and phrases may subsequently be used to generate one or more references that relate a particular code back to one or more terms or phrases within the EMR to which the code is particularly related. Next, a threshold 412 is applied to select the codes with the scores of greatest associated magnitudes as the codes to be associated with, or applied to, the EMR 404. In an example shown in FIG. 4, the codes with associated scores having magnitudes greater than or equal to 0.75 are selected as having sufficient probability of relatedness to information within the EMR to be associated with the EMR. As discussed above, the stream-comparison operation may be employed to compare a given EMR with the codes of a medical codebook or with the codes in a particular subset of the medical codebook.

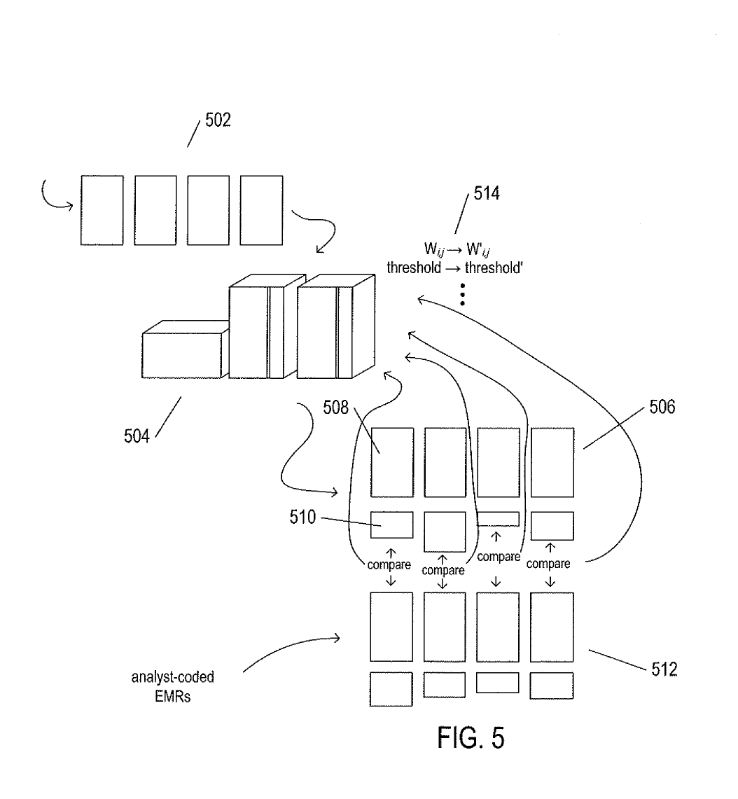

FIG. 5 illustrates training and feedback aspects of the disclosed methods and systems. As shown in FIG. 5, a set of training EMRs 502 is processed by the automated system 504 that assigns medical codes to EMRs to produce a set of code-annotated EMRs 506, as discussed above with reference to FIGS. 2-4. Using illustration conventions similar to those used in FIG. 2, each processed EMR, such as processed EMR 508, is associated with a set of codes, such as codes 510, with high probabilities of being related to the information contained in the EMR. In a next step, the same set of EMRs annotated by human analysts or by some other method 512 are compared, EMR-by-EMR, in order to determine a level of correspondence between the automatically generated medical-code assignments and those produced by human analysts or other means. The results of these comparisons are then, in a third step, used to adjust weights W_{i,j} and, in certain cases, one or more of the thresholds used in the automated assignment of individual medical codes to EMRs 514 so that the automated assignment of medical codes to EMRs more closely parallels or matches the assignments made by human analysts or other means.

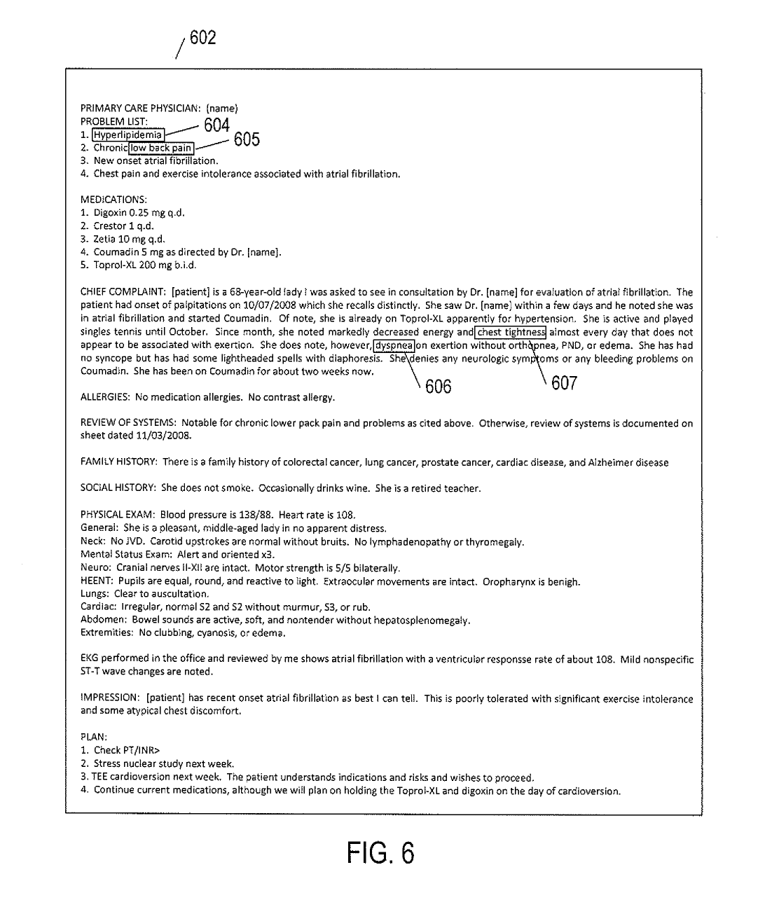

FIG. 6 shows an example of an electronic medical record. The EMR 602 is shown as a text document. An EMR may be stored as an electronic text-based document in any of many standardized and popular electronic document formats, such as those used to store text documents for processing by any of many different popular word-processing applications. An EMR may alternatively be stored within a database, various additional types of files, and in other formats and encodings. The terms or terms and phrases identified within the EMR and returned as streams are medical terms and phrases for use by a stream-comparison operation. Medical terms and phrases can be found in any of many different types of electronic references, or sources of medical terms and phrases, including online medical dictionaries, texts, and compiled lists of medical terms and phrases stored on one or more data-storage devices. Boxes 604-607 identify four examples of medical terms and phrases identified in the EMR 602 as a result of performing a text analysis as described in Atigeo U.S. patent application Ser. No. 13/960,054. The terms and phrase 604-607 become emrᵢ streams used by the agent to assign corresponding codes.

The streams generated from an EMR are therefore sets of medical terms or medical terms and phrases. They are referred to as streams because they are stored and processed in a way that allows successive terms and phrases to be extracted from the streams during the stream-comparison operation. There are many possible implementations of term or term-and-phrase streams commonly employed in a variety of different types of computational systems and applications.

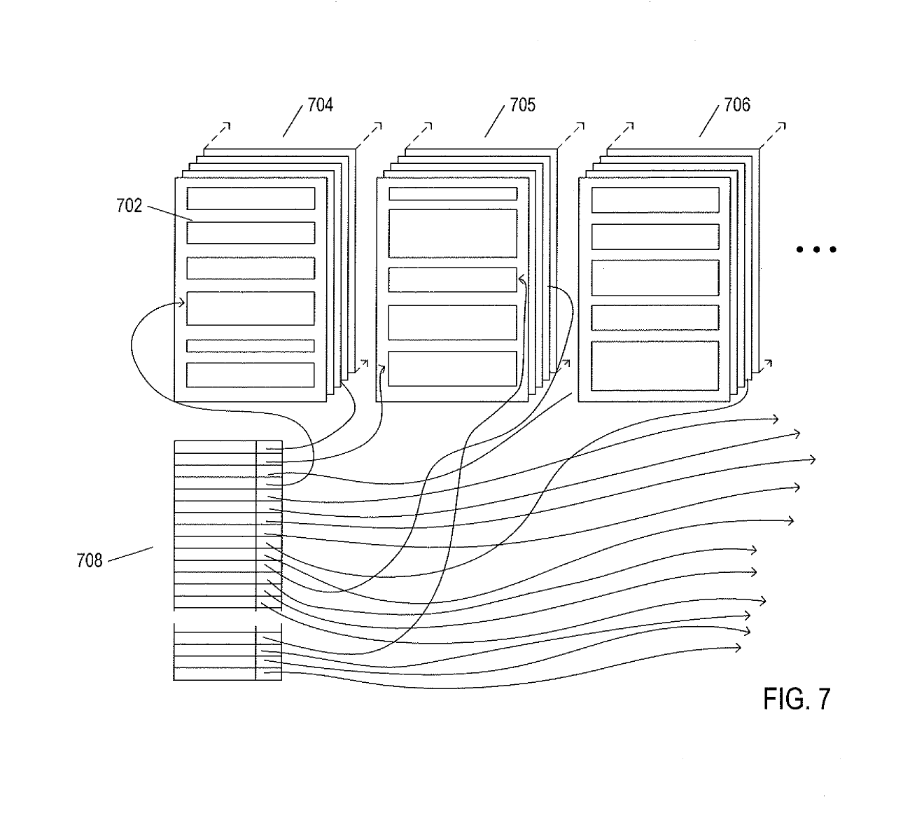

FIG. 7 illustrates organization of a typical medical codebook. The medical codebook comprises a large set of individual medical codes described by entries, such as entry 702. In general, the entries are sequentially as well as hierarchically organized. As shown in FIG. 7, the medical codebook is partitioned into chapters 704-706 and may be further partitioned, hierarchically, within chapters into sections, subsections, and other levels of organization. In addition, the medical codebook may have an index 708 that lists medical terms or terms and phrases along with references to individual medical codes, or entries, in the medical codebook related to the medical terms or terms and phrases.

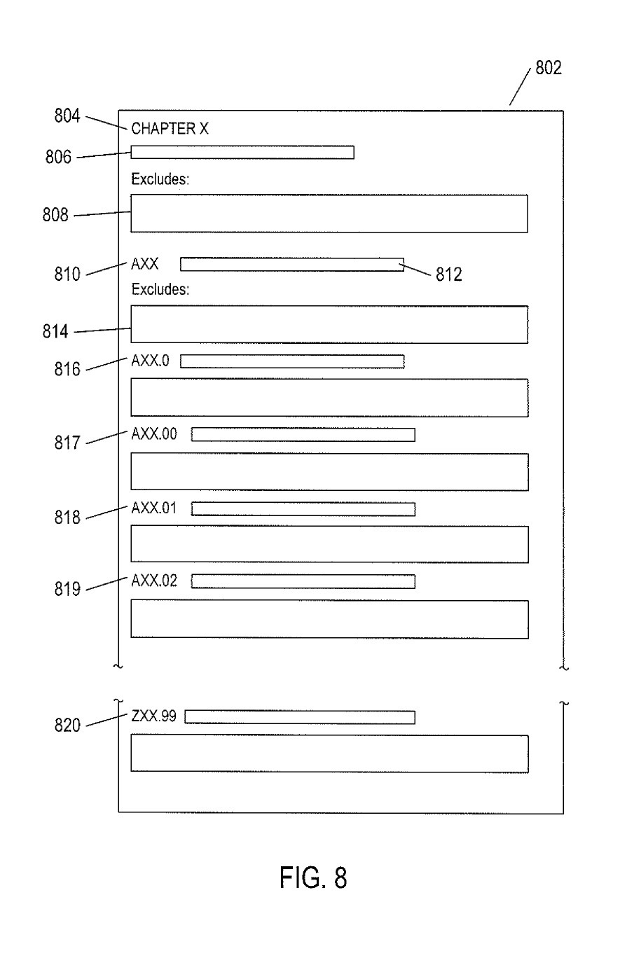

FIG. 8 illustrates one type of hierarchical organization within a medical codebook. FIG. 8 shows a portion of a chapter 802 of a medical codebook, the chapter including a chapter heading 804 along with a chapter title and/or description 806. The chapter may include an “excludes” section 808 that lists various types of medical terminology and concepts to which entries within the chapter are generally not related. The chapter next contains individual-code entries. In many cases, the individual codes are hierarchically organized. For example, a first code 810 within the chapter is represented by an alphanumeric code and includes a description and/or title 812. The entry for this code also includes an “excludes” section 814 and may include any of many additional sections. Following the initial code 810 are entries for hierarchically related codes 816-819. These related codes represent a first hierarchical level of subcodes underneath the initial code 810. A medical codebook may include an arbitrary number of levels of hierarchical codes below each first-level code. A medical-code chapter may include hundreds, thousands, tens of thousands or more individual-code entries. The final first-level code 820 is shown at the end of the representation of the chapter 802 in FIG. 8.

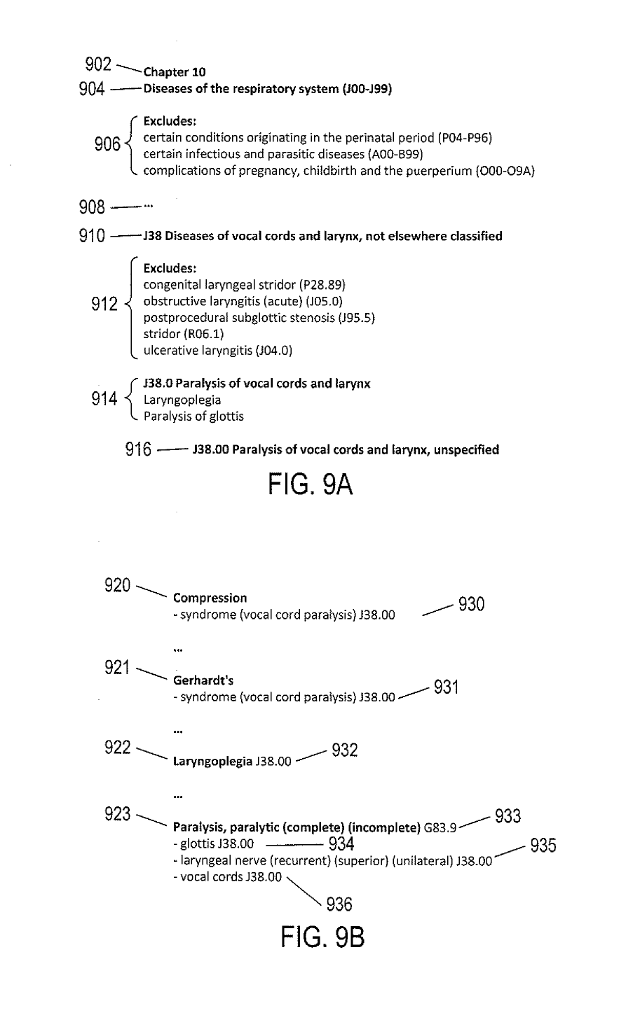

FIGS. 9A-9B show small portions of an actual medical codebook. FIG. 9A shows the beginning of a chapter within the medical codebook. This portion of the medical codebook includes a chapter header 902 and chapter title/summary 904. Next, there is an “excludes” section for the chapter 906. There may be additional sections and information pertaining to the chapter, as represented by ellipses 908. This chapter includes the top-level codes J00 through J99. The entry for the code J38 begins with the code and a title/summary 910 followed by an “excludes” section 912. Following the entry for code J38, an entry for the first, next-lower-level code, J38.0, is shown 914 followed by an entry for a next lower-level code J38.00 916. FIG. 9B shows a small portion of an index for the medical codebook illustrated in FIGS. 9A-9B. In FIG. 9B, a number of medical-term entries 920-923 are shown along with associated references 1430-1436 to the individual medical code J38.00 represented by entry 916 in FIG. 9A.

As discussed above, any particular implementation may use any of many different types of term or term-and-phrase streams generated from EMRs and from individual medical code entries within a medical codebook as a basis for conducting the stream-comparison operation discussed above with reference to FIG. 3. The stream-comparison operation uses these streams in order to compute a score, such as the score score(EMR(x),code(y)), the magnitude of which is related to the probability that a particular individual medical code within a medical codebook is related to the information contained within a particular EMR. An agent may also generate a document that reports a list of expected medical codes and associated scores that should be generated based on the context.

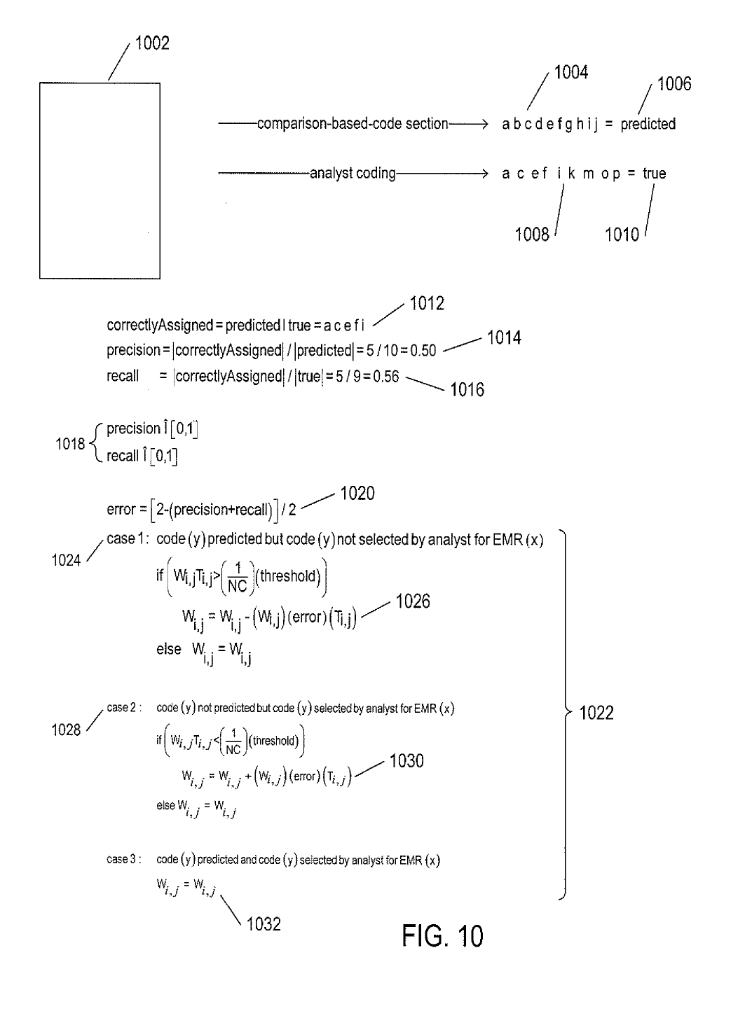

FIG. 10 illustrates aspects of the training compare operation, discussed above with reference to FIG. 5, in which medical codes associated with an EMR by an agent are compared to the medical codes associated with the same EMR by human analysts or by another method. At the top of FIG. 10, an EMR 1002 is subject to automated medical-code association to produce a set of individual medical codes 1004 referred to as the set “predicted” 1006. In FIG. 10, individual medical codes are represented by lower-case letters. Thus, for EMR 1002, the ten different individual medical codes represented by lower-case letters “a,” “b,” “c,” “d,” “e,” “f,” “g,” “h,” “i,” and “j” have been automatically associated with the EMR and included in the set predicted. The same EMR has been analyzed by human analysts, who have assigned nine different individual medical codes 1008 to the EMR which are together considered to comprise the set “true” 1010. In other words, the set “predicted” contains codes associated with the EMR by the automated medical-coding system and the set “true” includes the codes associated with the EMR by human analysts or by some other method.

A derived set and two different real-number values are next computed from the sets “predicted” and “true.” A set “correctlyAssigned” is constructed as the intersection of the elements of the sets “predicted” and “true” 1012. In the example shown in FIG. 10, the set “correctlyAssigned” includes five codes: “a,” “c,” “e,” “f,” and “i.” The value “precision” is computed as the ratio of the cardinality of the set “correctlyAssigned” to the cardinality of the set “predicted” 1014. In the current example, the value “precision” has the numeric value 0.5. Similarly, a real value “recall” is computed as a cardinality of the set “correctlyAssigned” divided by the cardinality of the set “true” 1016. In the current example, the numeric value of the value “recall” is 0.56. As indicated 1018 in FIG. 10, the values “precision” and “recall” fall within the range [0,1]. When the sets “predicted” and “true” contain the same codes, both the precision and recall have value 1.0. When the sets “predicted” and “true” contain no common codes, the values “precision” and “recall” are both 0.0.

One measure of the error in automated code assignment is:

$$error = \frac{[ 2 - ( precision + recall ) ]}{2}$$

as shown 1020 in FIG. 10. This error value can be used in order to adjust the weights used to compute scores during training of an automated system that assigns medical codes to EMRs. Weight adjustment is expressed by the pseudocode 1022 shown in FIG. 10. When a particular code, code(y), is associated by the automated system with an EMR but was not associated by human analysts with the EMR, representing case 1 1024, then any weights W_{i,j} within terms W_{i,j}T_{i,j} in the computation of the score for the EMR and code that contributed significantly to the score are adjusted downward 1026 by an amount proportional to the computed error and the magnitude of the term. Similarly, when a particular code, code(y), was not associated with EMR by the automated system but was associated with the EMR by human analysts, representing case 1028, then all of the weights W_{i,j} within terms W_{i,j}T_{i,j} that did not significantly contribute to the magnitude of the score computed for the EMR in code are adjusted upward 1030. When the code, code(y), is both predicted by the automated system and selected by human analysts, then no adjustment to the weights is made 1032. This represents just one of many different possible weight-adjustment schemes. In addition, the threshold used for selecting related codes, discussed above with reference to FIG. 4, can be adjusted upward or downward to decrease or increase the number of codes typically associated by an automated medical-coding system to an EMR.

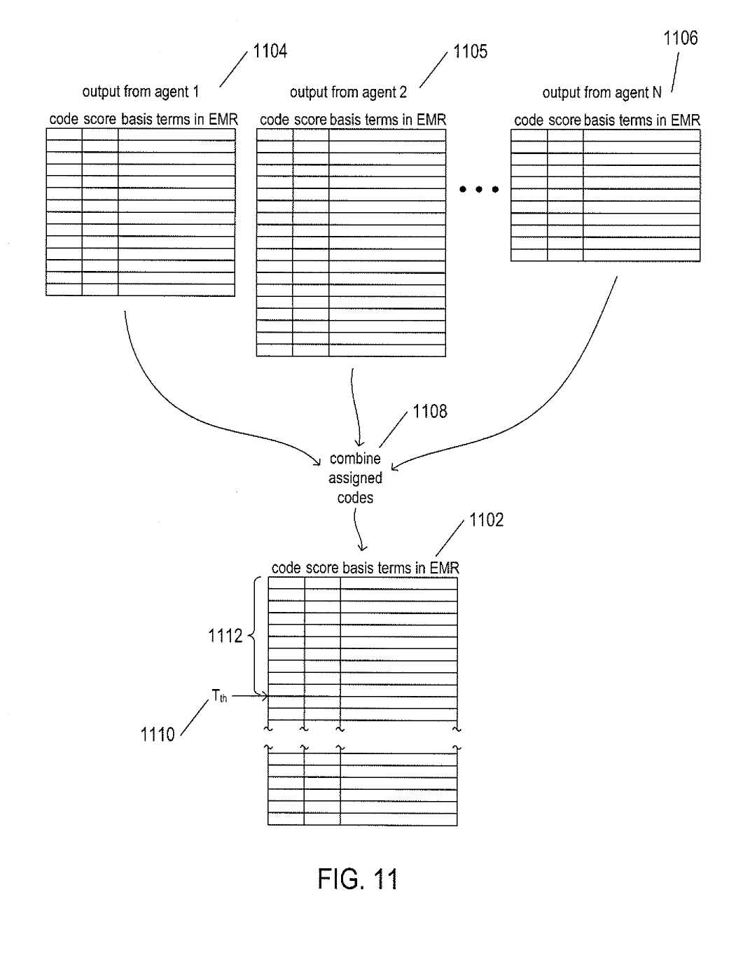

After the N agents have generated N medical code assignments, the medical code assignments are combined to generate a final medical-code assignment that can be used to annotate an EMR. FIG. 11 illustrates a list of code/score pairs 1102 for a final medical-code assignment generated by combining assigned codes/score pairs of N different medical-code assignments, each generated by a different agent. Lists 1104-1106 represent code/score pairs for three of N lists of different code/score pairs of N different medical-code assignments. This example assumes the convention in which the codes are listed from top to bottom according to associated decreasing score magnitude. Because each of the N agents may implement a different method for assigning scores to codes, the N code/score lists may be of different lengths, as represented by example code/score lists 1104-1106. The code/score lists may all have a number of codes in common, but with different associated scores, and each of the code/score lists may contain codes and associated scores that are unique to only one or a fraction of the N code/score lists. The method described below combines 1108 the N code/score pairs generated by the N agents to generate the list of code/scores pairs 1102 associated with a final medical-code assignment. A threshold, Tₜₕ, 1110 is applied to select the codes 1112 with the scores of greatest associated magnitudes as the codes to be associated with, or applied to, the final medical-code assignment.

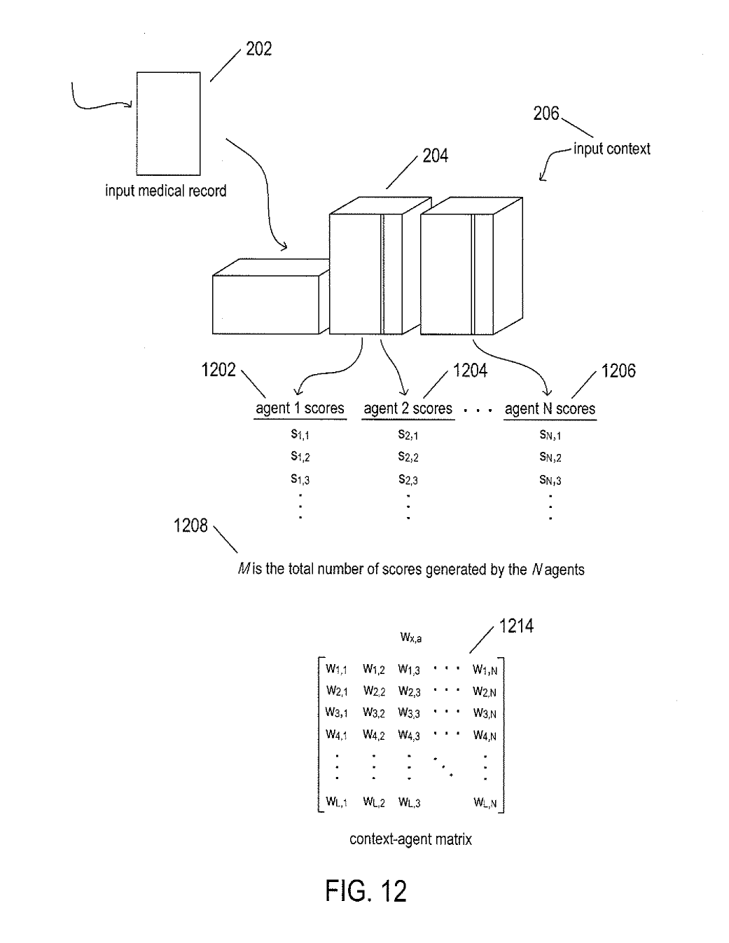

FIG. 12 illustrates a collection of scores generated by N different agents. As discusses above, the system 204 uses N different agents to generate codes and associated scores based on a context 206 for the input EMR 202. The codes and scores are stored electronically within a database, various additional type of files, and may be stored in various formats. Lists 1202, 1204, and 1206 represent scores generated by agents 1, 2, and N. In the following discussion, each score is denoted by, s_{a,c}, where the subscript “a” is an agent index that ranges from 1 to N, and the subscript “c” is a code index. The N agents generate a total of M 1208 codes and associated scores. The system 204 also stores context-agent weights represented by a context-agent matrix 1214. Each context-agent weight is a real number denoted by, w_{x,a}, where the subscript “x” is a context index that ranges from 1 to L, and L represents the full number of contexts. The context-agent weights may be initialized by assigning each weight the value “1.”

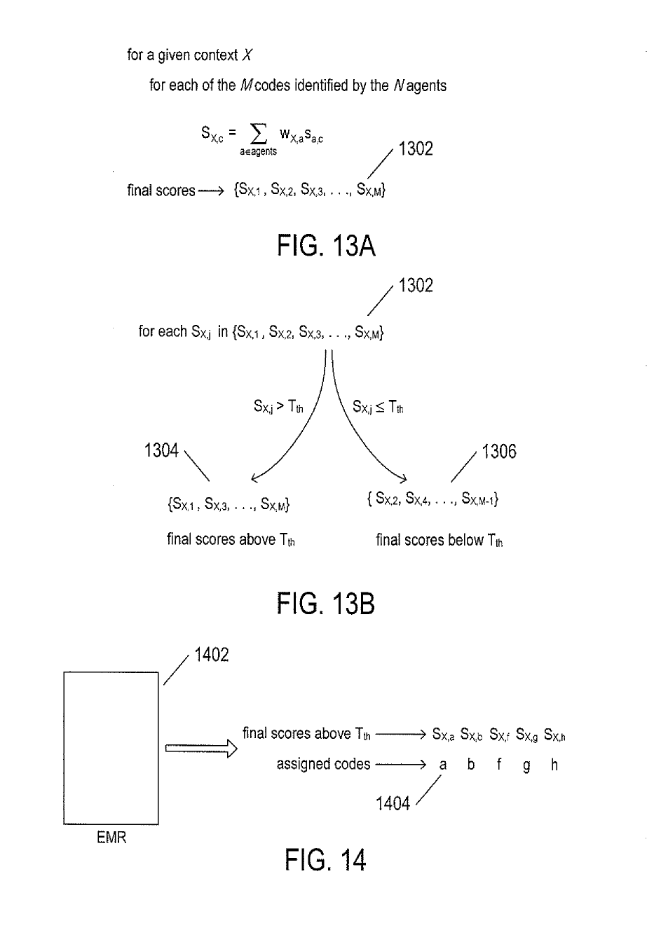

FIGS. 13A-13B illustrate generating a set of final scores and codes for an EMR with respect to a particular context. In FIG. 13A, a final score S_{X,c} for a particular code c within a given context, denoted by “X,” for an EMR is calculated according to a final score function given by:

$${S}_{X , c} = {\sum }_{a ∈ agent} {w}_{X , a} {s}_{a , c}$$

where 1≦X≦L.

A final score S_{X,c} is calculated for each of the M codes identified by the N agents to give a set of final scores 1302. In FIG. 13B, the final scores are separated according to the threshold, Tₜₕ, into a set of final scores above the threshold 1304 and a set of final scores below the threshold 1306. The codes associated with the set of final scores that are above the threshold 1304 are the codes in the final medical code assignment for the terms and phrases of the EMR and are used to produce the final code-annotated EMR.

The N different agents may also generate expected medical codes and associated scores based on the context. The method includes storing and maintaining a context-agent matrix for the expected codes, as described above with reference to FIG. 12 Final scores are also calculated for the expected codes as described above with reference to FIGS. 13A-13B.

FIG. 14 illustrates final results generated by an automated system that receives an EMR 1402 and combines predictions of multiple medical code assignments generated by a number of different agents to generate a final medical code assignment 1404, with respect to a particular context X. Thus, for EMR 1402, the five final scores are represented by S_{X,a}, S_{X,b}, S_{X,f}, S_{X,g}, and S_{X,h} with associated final medical codes represented by lower-case letters “a,” “b,” “f,” “g,” and “h.” The final medical codes 1404 and associated final code-annotated EMR assignment may be sent to a code reporting system that handles the assigned codes for purposes of billing and record-keeping.

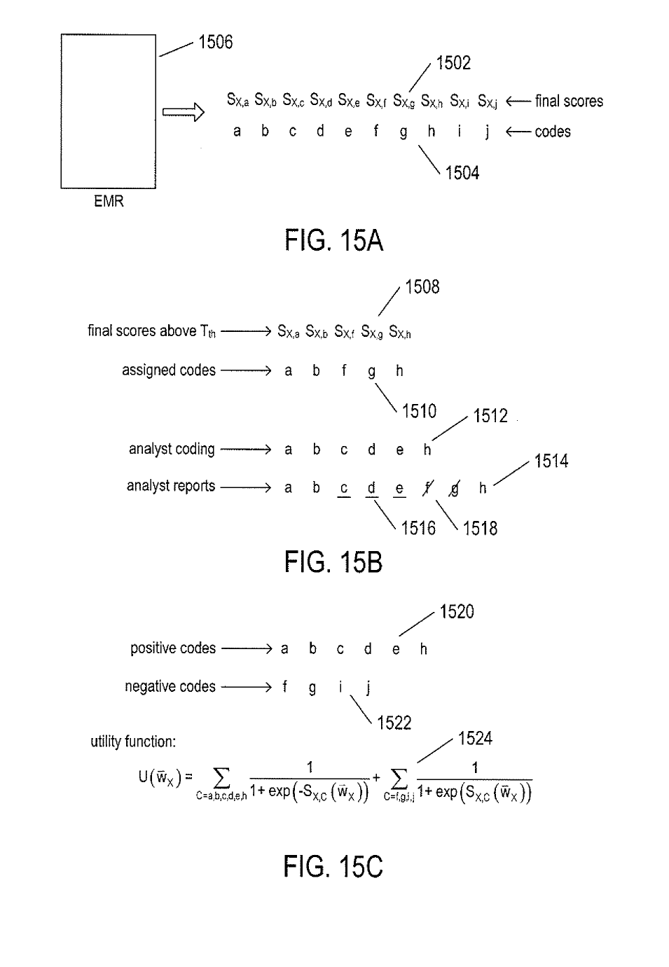

As described above, the context-agent weights w_{x,a} may be initialized to “1,” and may have to be adjusted or trained. FIGS. 15A-15C illustrate aspects of updating context-agent weights. FIG. 15A illustrates a set of final scores 1502 and associated codes 1504 generated for an EMR 1506 with respect to a particular context X. The associated codes 1504 are represented by letters “a,” “b,” “c,” “d,” “e,” “f,” “g,” “h,” “i,” and “j.”

FIG. 15B illustrates a set of final scores 1508 that are greater than a threshold Tₜₕ and associated medical codes 1510 that are a subset of the codes 1504. The same EMR 1506 has been analyzed by human analysts, or by some other analytical method, who have assigned six different individual medical codes 1512 to the EMR 1506, which are considered to the set of final correct medical codes to be used in annotating the EMR 1506. The analysts generates an analyst report 1514 that identifies the codes that were added 1516 by the analyst, as identified by underlining, and codes that were deleted 1518 by the analyst, as indicated by hash marks.

The context-agent weights are updated for each context by optimizing a utility function, while holding the M scores s_{a,c} generated by the N agents constant. One type of utility function that may be useful in updating the context-agent weights is given by:

$$U ( {\vec{w}}_{X} ) = {\sum }_{c ∈ positive} \frac{1}{1 + exp ( - {S}_{X , c} ( {\vec{w}}_{X} ) )} + {\sum }_{c ∈ negative} \frac{1}{1 + exp ( {S}_{X , c} ( {\vec{w}}_{X} ) )}$$

where
S_{X,c} represents the final score function;
\vec{w}_{X} represents the context-agent weights for the context X;
“positive” represents a set of codes that have been identified by the analyst as being correct; and
“negative” represents a set of codes that have been identified by the analyst as being incorrectly assigned and codes generated by the automated system with associated score below the threshold Tₜₕ.

Note that the terms “positive” and “negative” are not used to refer to the numerical sign (e.g., “+” or “−”) but are instead used to identify codes that been identified by an analyst as being correctly (i.e., positive) or incorrectly (i.e., negative) assigned. The utility function is optimized with respect the context-agent weights \vec{w}_{X}. In other words, the context-agent weights \vec{w}_{X} that satisfy the condition dU(\vec{w}_{X})/\vec{w}_{X}=0 (i.e., maximize or minimize the utility function) are calculated and used to replace the previous context-agent weights \vec{w}_{X}. A number of computational methods can be used to optimize the utility function U(\vec{w}_{X}) with respect to the context-agent weights \vec{w}_{X} including, for example, the Broyden-Fletcher-Goldfarb-Shanno (“BFGS”) optimization method, the limited-memory BFGS, or another Newton method-based optimization.

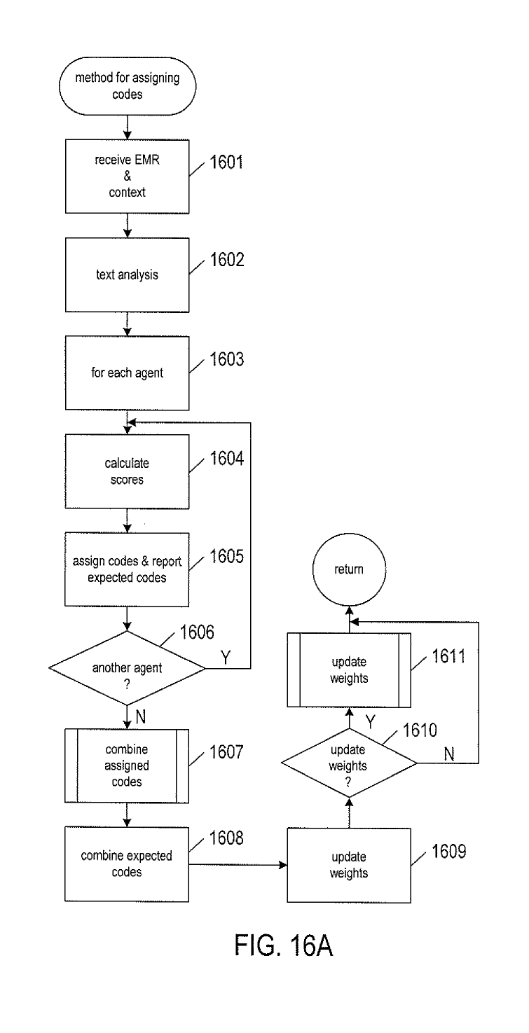

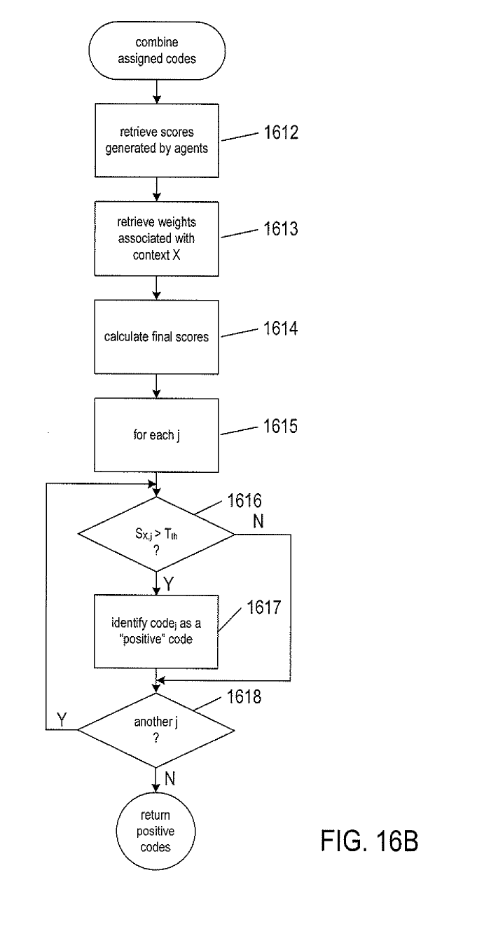

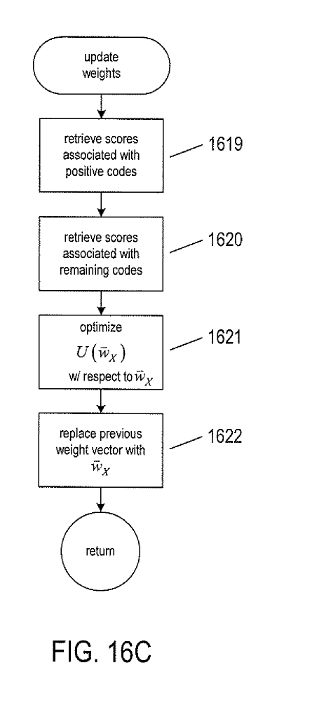

FIG. 15C illustrates an example of constructing a utility function for the example codes of FIGS. 15A-15B. Positive codes 1520 are the codes 1512 identified by the analyst, and negative codes 1522 are the incorrectly identified codes “f” and “g” 1518 and the codes “i” and “j” that were generated by the automated system with associated scores below the threshold Tₜₕ. The positive and negative codes 1520 and 1522 are used to formulate the utility function 1524 that can be optimized to determine context-agent weights \vec{w}_{X} for a context X. FIGS. 16A-16C provide control-flow diagrams that illustrate one implementation of an automated system that assigns medical codes to EMRs. FIG. 16A provides a control-flow diagram for a routine that represents the highest level of an example implementation of the currently disclosed methods and systems. In block 1601, the routine receives an EMR for coding an associated context for the EMR and output channel to which final medical code assignments are to be output. In block 1602, the text of the EMR is analyzed in order to identify and extract terms and phrases that can be associated with codes of one or more medical codebooks, as described above with reference to FIG. 6. In the for-loop of blocks 1603-1606, the routine executes the operations in blocks 1604-1606 for each agent. In block 1604, an agent receives the terms and phrases extracted from the EMR and calculates scores for codes that correspond to the terms and phrases, as described above with reference to FIG. 3. In block 1605, the agent assigns the codes above a threshold to the terms and phrases as described above with reference to FIGS. 7-9, and also generates expected codes based on the context. In block 1606, when another agent is available, the operations of block 1604 and 1605 are repeated for the agent. One method for implementing the blocks 1604 and 1605 for at least one of the agents is described in U.S. patent application Ser. No. 13/960,054 cited above. In block 1607, a routine “combine codes” is called to combine the medical codes generated by each of the agents to generate a final medical code assignment for the EMR. In block 1608, the routine “combine codes” is again called to combine the expected medical codes generated by each of the agents to generate a final expected medical code assignment for the EMR. In block 1609, the final medical code assignment is reported for purposed of billing and record keeping. In block 1610, when weights used to calculate the final medical code assignment are to be updated, the method proceeds to block 1611. In block 1611, the routine “update weights” is called to carry out updating the weights used to generate the final medical code assignment.

FIG. 16B shows a control-flow diagram for the routine “combine codes” called in block 1607 of the control-flow diagram of FIG. 16A. In block 1612, the scores calculated by each of the agents are retrieved, as described above with reference to FIG. 12. In block 1613, context-agent weights associated with context and stored in the automated system are retrieved. In block 1614, final scores are calculated for each code as described above with reference to FIG. 13A. In the for-loop of blocks 1615-1616, the routine executes the operations in blocks 1616-1618 for each of M codes identified by the agents. In block 1604, when a final score is greater than the threshold Tₜₕ, the method proceeds to block 1617, in which the associated code is identified as a positive code. Otherwise, the method returns and repeats blocks 1616 for the next final score. When the routine “combine assigned codes” is finished, the final codes associated with scores greater than the threshold are returned.

FIG. 16C shows a control-flow diagram for the routine “update weights” called in block 1611 of the control-flow diagram of FIG. 16A. In block 1619, scores associated with positive codes are retrieved. The positive codes are the positive codes identified by an analyst, such as a human analyst or another method, as described above with reference to FIG. 15C. In block 1620, scores associated negative codes are retrieved. The negative codes are identified by an analyst and may include final scores that are less than the threshold, as described above with reference to FIG. 15C. In block 1621, the context-agent weights and the scores retrieved in blocks 1619 and 1620 are used to formulate a utility function U(\vec{w}_{X}), which is optimized to determine context-agent weights while holding the scores fixed, as described above. In block 1622, the context-agent weights obtained in block 1621 are used to replace the previous set of context-agent weights.

Although the present invention has been described in terms of particular embodiments, it is not intended that the invention be limited to these embodiments. Modifications within the spirit of the invention will be apparent to those skilled in the art. For example, any of a variety of different implementations of an automated medical-code-assignment system can be obtained by varying any of many different design and development parameters, including programming language, underlying operating system, modular organization, control structures, data structures, and other such design and development parameters. A variety of different specific implementations of the stream-comparison operation and comparison operations used for training are possible. In alternative implementations, an automated medical-coding system may assign sets of codes extracted from two or more different medical codes to each EMR.

It is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An automated medical-coding system comprising:
one or more processors;
one or more memories; and
computer instructions stored in one or more data-storage components of the automated medical-coding system that, when transferred to one or the one or more memories and executed by one of the one or more professors, control the automated medical-coding system to
receive an electronic medical record and an associated context,
identify terms or terms and phrases of the electronic medical record,
executes two or more different agents that compute two or more medical code assignments, each medical code assignment assigns medical codes of a medical codebook to the terms or terms and phrases in accordance with the context,
combine the two or more medical code assignments to generate a final medical code assignment,
annotate the electronic medical record with the medical codes in the final medical code assignment, and
store a final annotated electronic medical record in at least one of the one or more memories.

2. The system of claim 1, wherein identify the terms or terms and phrases of the electronic medical record further comprises accessing a set of electronically stored entries, each entry a terms or phrase, that can be accessed entry-by-entry as a stream of entities.

3. The system of claim 1, wherein executes two or more different agents that compute two or more medical code assignments comprises:
for each agent,
for each of multiple individual medical codes of the medical codebook,
computing a score for each of the multiple individual medical codes based on a method implemented by the agent for comparing the terms or terms and phrases of the electronic medical record and the terms from the individual medical code; and
selecting individual medical codes based on the computed scores.

4. The system of claim 1, wherein the two or more different agents each implement a different method for computing a score that represents a level of confidence between the terms or terms and phrases of the electronic medical record and the terms from the individual medical code.

5. The system of claim 1, wherein combine the two or more medical code assignments to generate the final medical code assignment comprises:
for each code of the two or more medical code assignments,
computing a final score as a function of scores computed by the two or more agents and weights, each score corresponds to a code in one or the medical code assignments generated by a corresponding agent, and each weight represents a level of importance to attribute to the score based on the agent and the context; and
selecting final codes for the final medical code assignment that have associated final scores greater than a threshold.

6. The system of claim 1, further comprises updating context and agent dependent weights used to combine the two or more medical code assignments to generate the final medical code assignment.

7. The system of claim 6, wherein updating the context and agent dependent weights further comprises
formulating a utility function as a function of the weights and scores generated by the agents;
optimizing the utility function with respect to the weights, holding the scores fixed; and
replacing previously stored context and agent dependent weights.

8. The system of claim 1, wherein each agent generates expected medical codes associated with the context and the system combines the two or more medical expected medical codes to generate final expected medical codes, and stores the final expected medical codes in at least one of the one or more memories.

9. A method that automatically assigns individual medical codes to an electronic medical record within a system that includes one or more processors and one or more memories, the method comprising:
receiving an electronic medical record and an associated context,
identifying terms or terms and phrases of the electronic medical record,
executing two or more different agents that compute two or more medical code assignments, each medical code assignment assigns medical codes of a medical codebook to the terms or terms and phrases in accordance with the context,
combining the two or more medical code assignments to generate a final medical code assignment,
annotating the electronic medical record with the medical codes in the final medical code assignment, and
storing a final annotated electronic medical record in at least one of the one or more memories.

10. The method of claim 9, wherein identify the terms or terms and phrases of the electronic medical record further comprises accessing a set of electronically stored entries, each entry a terms or phrase, that can be accessed entry-by-entry as a stream of entities.

11. The method of claim 9, wherein executes two or more different agents that compute two or more medical code assignments comprises:
for each agent,
for each of multiple individual medical codes of the medical codebook,
computing a score for each of the multiple individual medical codes based on a method implemented by the agent for comparing the terms or terms and phrases of the electronic medical record and the terms from the individual medical code; and
selecting individual medical codes based on the computed scores.

12. The method of claim 9, wherein the two or more different agents each implement a different method for computing a score that represents a level of confidence between the terms or terms and phrases of the electronic medical record and the terms from the individual medical code.

13. The method of claim 9, wherein combine the two or more medical code assignments to generate the final medical code assignment comprises:
for each code of the two or more medical code assignments,
computing a final score as a function of scores computed by the two or more agents and weights, each score corresponds to a code in one or the medical code assignments generated by a corresponding agent, and each weight represents a level of importance to attribute to the score based on the agent and the context; and
selecting final codes for the final medical code assignment that have associated final scores greater than a threshold.

14. The method of claim 9, further comprises updating context and agent dependent weights used to combine the two or more medical code assignments to generate the final medical code assignment.

15. The method of claim 14, wherein updating the context and agent dependent weights further comprises
formulating a utility function as a function of the weights and scores generated by the agents;
optimizing the utility function with respect to the weights, holding the scores fixed; and
replacing previously stored context and agent dependent weights.

16. The method of claim 9, wherein each agent generates expected medical codes associated with the context and the system combines the two or more medical expected medical codes to generate final expected medical codes, and stores the final expected medical codes in at least one of the one or more memories.

17. A physical computer-readable medium having machine-readable instructions encoded thereon for enabling one or more processors of a computer system to perform the operations of
receiving an electronic medical record and an associated context,
identifying terms or terms and phrases of the electronic medical record,
executing two or more different agents that compute two or more medical code assignments, each medical code assignment assigns medical codes of a medical codebook to the terms or terms and phrases in accordance with the context,
combining the two or more medical code assignments to generate a final medical code assignment,
annotating the electronic medical record with the medical codes in the final medical code assignment, and
storing a final annotated electronic medical record in at least one of the one or more memories.

18. The medium of claim 17, wherein identify the terms or terms and phrases of the electronic medical record further comprises accessing a set of electronically stored entries, each entry a terms or phrase, that can be accessed entry-by-entry as a stream of entities.

19. The medium of claim 17, wherein executes two or more different agents that compute two or more medical code assignments comprises:
for each agent,
for each of multiple individual medical codes of the medical codebook,
computing a score for each of the multiple individual medical codes based on a method implemented by the agent for comparing the terms or terms and phrases of the electronic medical record and the terms from the individual medical code; and
selecting individual medical codes based on the computed scores.

20. The medium of claim 17, wherein the two or more different agents each implement a different method for computing a score that represents a level of confidence between the terms or terms and phrases of the electronic medical record and the terms from the individual medical code.

21. The medium of claim 17, wherein combine the two or more medical code assignments to generate the final medical code assignment comprises:
for each code of the two or more medical code assignments,
computing a final score as a function of scores computed by the two or more agents and weights, each score corresponds to a code in one or the medical code assignments generated by a corresponding agent, and each weight represents a level of importance to attribute to the score based on the agent and the context; and
selecting final codes for the final medical code assignment that have associated final scores greater than a threshold.

22. The medium of claim 17, wherein each agent generates expected medical codes associated with the context and the system combines the two or more medical expected medical codes to generate final expected medical codes, and stores the final expected medical codes in at least one of the one or more memories.
